(19) United States
(12) Patent Application Publication
(10) Pub. No.: US 2009/0021811 A1
(43) Pub. Date: Jan. 22, 2009

(54) OPTICAL INFORMATION RECORDING APPARATUS

(75) Inventors: Yuichiro Yamamoto, Tokyo (JP); Shinichi Tatsuta, Tokyo (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/040,994

(22) Filed: Mar. 3, 2008

(30) Foreign Application Priority Data
Jul. 17, 2007 (JP) 2007-186026

(51) Int. Cl. G03H 1/02; G03H 1/04

(52) U.S. Cl. 359/3; 359/30

(57) ABSTRACT

An optical information recording apparatus includes a light source that emits an irradiation light; a spatial light modulator that converts the irradiation light to an information light carrying information; a condenser lens that converges the information light and a reference light onto an optical information recording medium on which the information can be recorded as a hologram by an interference fringe formed by an interference between the information light and the reference light; a relay lens that propagates the information light emitted from the spatial light modulator to the condenser lens; and a permeable member, provided between the spatial light modulator and the relay lens, that has a refractive index greater than a refractive index of air and smaller than a refractive index of the relay lens, and refracts and transmits the information light.

### CROSS-REFERENCE TO RELATED APPLICATIONS

This application is based upon and claims the benefit of priority from the prior Japanese Patent Application No. 2007-186026, filed on Jul. 17, 2007; the entire contents of which are incorporated herein by reference.

### BACKGROUND OF THE INVENTION

1. Field of the Invention

The present invention relates to an optical information recording apparatus that records information onto an optical information recording medium as a hologram.

2. Description of the Related Art

An increase in capacity of conventional optical disks, from compact discs (CD) to high definition versatile discs (HD DVD), and Blu-ray Discs, has been achieved through shortening of laser beam wavelengths and an increase in numerical aperture of objective lenses. The conventional optical disks are considered to be approaching system limits as a result of use of HD DVD, and Blu-ray Disc technologies using a blue-violet semiconductor laser having a wavelength of 405 nanometers. To achieve further significant increase in optical disk capacity, a new recording and reproducing system is required to be established. Under such circumstances, various systems, such as volumetric recording, multi-layered recording, and near-field recording, are being proposed as a next-generation, high-density optical storage. Feasibility of these various systems is also being discussed. Among the various systems, a volumetric-recording optical disk using holography is considered to be a strong candidate for the next-generation, high-density optical storage. In recent years, development of high-sensitivity holographic recording media, experiments supporting capacity increase, and the like have been successively disclosed. Research and development focusing on practical application of the volumetric-recording optical disk using holography is being vigorously promoted.

A recording principle behind the volumetric-recording optical disk using holography (referred to, hereinafter, as a “holographic optical disk”) is as follows. Interference is generated between an information light and a reference light within an information recording layer in the holographic optical disk. As a result, information is recorded in three-dimensional form onto the information recording layer as a fine interference fringe. A plurality of pieces of information (page data) can be multiple-recorded in a same area or in overlapping areas within the information recording layer of the holographic optical disk. Therefore, a significantly larger increase in capacity can be achieved compared to current optical disks, such as the HD DVD, and the Blu-ray Disc, in which information is recorded onto a flat surface using pits and marks.

A recording and reproducing system of the holographic optical disk is largely divided into a two-beam system and a coaxial system (collinear system). In the two-beam system, the information light and the reference light enter the information recording layer of the optical disk through different paths and interfere with each other. In the coaxial system, the information light and the reference light coaxially enter the information recording layer of the optical disk and interfere with each other.

In the two-beam system, for example, a laser beam emitted from a light source, such as a semiconductor laser, is divided into two light beams by a polarizing beam splitter. Between the two divided light beams, a light beam that has passed through the polarizing beam splitter enters a spatial light modulator. The spatial light modulator performs an intensity modulation or a phase modulation on the light beam. The light beam is converted to the information light carrying information. An objective lens then converges the information light onto the recording layer of the holographic optical disk. The information light is irradiated onto the information recording layer.

At the same time, as disclosed in FIG. 1 in JP-A 2007-10821 (KOKAI), a light beam reflected by the polarizing beam splitter is polarized in a same direction as the information light by a wave plate. A beam reducing system reduces a diameter of the light beam to a predetermined beam diameter. The light beam is then irradiated onto the information recording layer of the holographic optical disk as the reference light. The information light and the reference light are superimposed on the information recording layer of the holographic optical disk. The information is recorded as the fine interference fringe.

In an optical system such as this, a spatial filter is commonly disposed between the spatial light modulator and the objective lens. The spatial filter includes a pair of relay lenses and an iris diaphragm.

In a holographic recording system such as that described above, when a shifted, multi-layered recording is performed as a method of recording a plurality of pieces of page data onto a same area of the holographic optical disk, the beam diameter of the information light entering the holographic optical disk is preferably minimized. In the shifted, multi-layered recording, the page data is recorded while a position at which the laser beam is irradiated onto the holographic optical disk is slightly shifted.

When a wavelength of the laser beam in air is λ₀, a pixel pitch of the spatial light modulator is P, a focal distance of a relay lens on the spatial light modulator side is f₁, a focal distance of a relay lens on the objective lens side is f₂, and a focal distance of the objective lens is f₃, based on disposal relationships among the spatial light modulator, the relay lenses, the objective lens, and the holographic optical disk, a beam diameter D of the information light entering the holographic optical disk is expressed by a following expression (1).

$$D = 2 \frac{{λ}_{0}}{P} {f}_{1} \cdot \frac{{f}_{3}}{{f}_{2}} \qquad ( 1 )$$

From the expression (1), a shortening of the wavelength λ₀ of the laser beam, an increase in the pixel pitch P of the spatial light modulator, a shortening of the focal distance f₁ of the relay lens on the spatial light modulator side, a lengthening of the focal distance f₂ of the relay lens on the objective lens side, or a shortening of the focal distance f₃ of the objective lens can be considered to reduce the beam diameter D of the information light.

However, the reduction of the beam diameter of the information light has a trade-off relationship with size reduction of a holographic recording device and securing of an optical path within the optical system. In other words, the shortening of the wavelength of the laser beam to a wavelength shorter than a wavelength of 405 nanometers of the currently used blue-violet laser is not realistic. When the pixel pitch of the spatial light modulator increases, an amount of data modulated by the spatial light modulator decreases. Taking into consideration a size of the spatial light modulator based on the pixel pitch, a significant shortening of the focal distance of the relay lens on the spatial light modulator side is difficult to achieve because a certain amount of lens aperture is required. Regarding the lengthening of the focal distance of the relay lens on the objective lens side, the optical system becomes excessively large when the optical path is extended, thereby increasing the size of the holographic recording device. The shortening of the focal distance of the objective lens is difficult to achieve because an incidence path for the reference light is required to be secured, and the holographic recording device may increase in size.

### SUMMARY OF THE INVENTION

According to one aspect of the present invention, a n optical information recording apparatus includes a light source that emits an irradiation light; a spatial light modulator that converts the irradiation light to an information light carrying information; a condenser lens that converges the information light and a reference light onto an optical information recording medium on which the information can be recorded as a hologram by an interference fringe formed by an interference between the information light and the reference light; a relay lens that propagates the information light emitted from the spatial light modulator to the condenserilens; and a permeable member that is provided between the spatial light modulator and the relay lens, has a refractive index greater than a refractive index of air and smaller than a refractive index of the relay lens, and refracts and transmits the information light.

### BRIEF DESCRIPTION OF THE DRAWINGS

FIG. 1 is a configuration diagram of an optical information recording/reproducing apparatus according to a first embodiment;

FIG. 2 is an enlarged view of an optical system according to the first embodiment;

FIG. 3 is a schematic diagram of an information light irradiation state in the optical system;

FIG. 4 is a schematic diagram of an irradiation state of a light from a single pixel of a spatial light modulator;

FIG. 5 is a schematic diagram explaining a design example of a relay lens;

FIG. 6 is a configuration diagram of an optical information recording/reproducing apparatus according to a second embodiment;

FIG. 7 is an enlarged view of an optical system according to the second embodiment; and

FIG. 8 is an enlarged view of an optical system according to 0 third embodiment.

### DETAILED DESCRIPTION OF THE INVENTION

Exemplary embodiments of the present invention are below described with reference to the attached drawings.

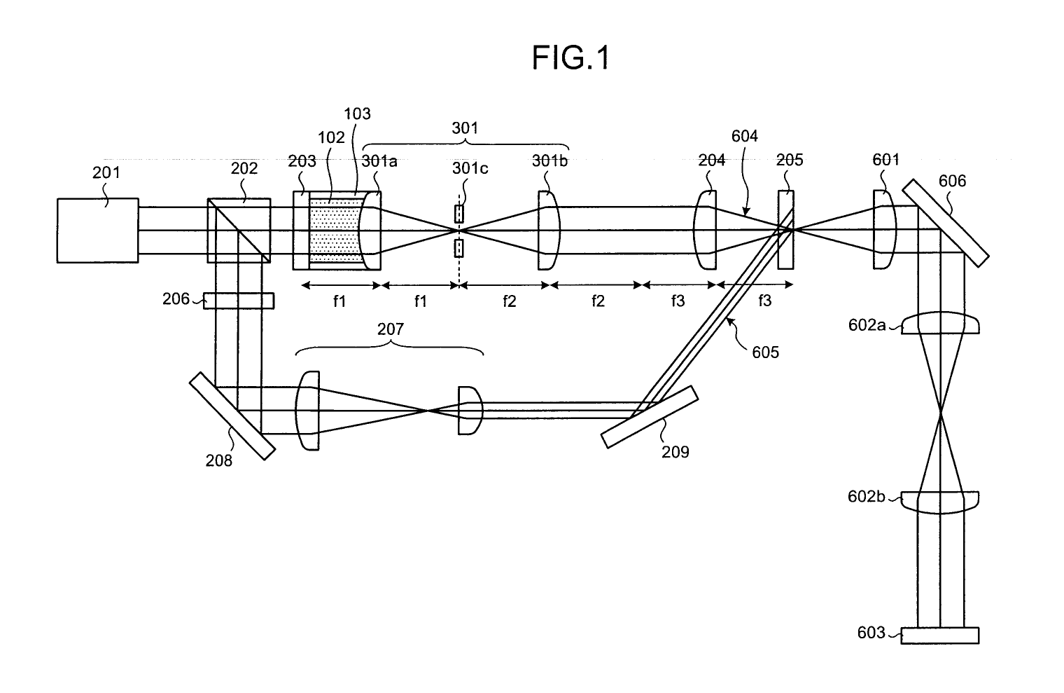

FIG. 1 is a configuration diagram of an optical system in an optical information recording/reproducing apparatus according to a first embodiment. The optical system referred to herein extends from a spatial light modulator, described hereafter, to a holographic optical disk. The optical information recording/reproducing apparatus according to the first embodiment records information onto an information recording layer of a holographic optical disk 205 as a hologram by generating interference between an information light and a reference light. The optical information recording/reproducing apparatus reproduces the information recorded onto the information recording layer of the holographic optical disk 205 by irradiating the reference light onto the holographic optical disk 205. The optical information recording/reproducing apparatus according to the embodiment uses a two-beam system in which the information light and the reference light enter a recording layer of an optical disk from differing angles and interfere with each other.

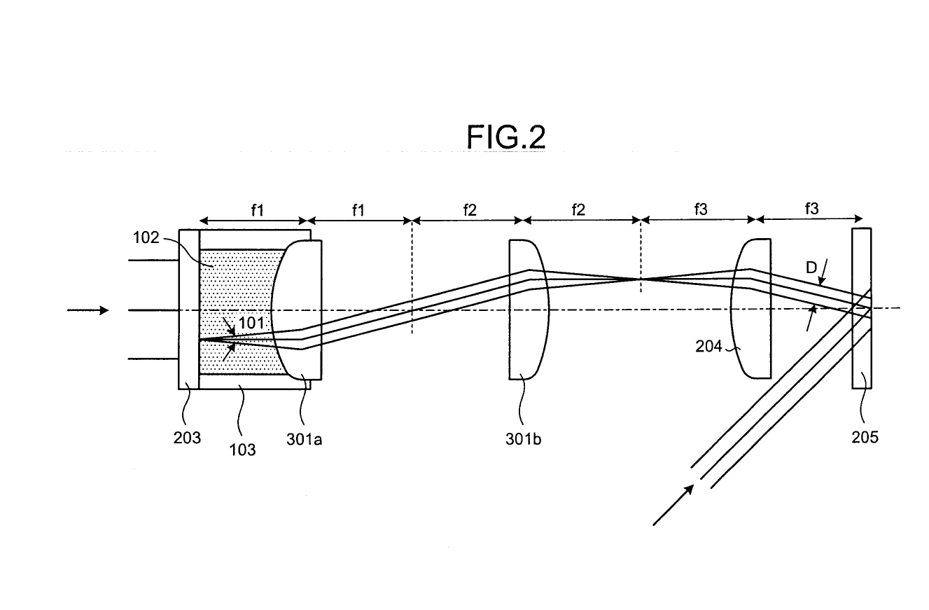

The optical system of the optical information recording/reproducing apparatus according to the first embodiment mainly includes a semiconductor laser 201, a polarizing beam splitter 202, a spatial light modulator 203, a holding component 103, a spatial filter 301, objective lenses 204 and 601, a wavelength plate 206, mirrors 208, 209, and 606, a beam reducing optical system 207, relay lenses 602a and 603b, and a two-dimensional image sensor element 603. The semiconductor laser 201 emits a laser beam. The holding component 103 is filled with a permeable material 102. The two-dimensional image sensor element 603 is, for example, a complementary metal-oxide-semiconductor (CMOS) or a charge-coupled device (CCD). FIG. 1 shows an optical system for recording and an optical system for reproducing. FIG. 2 is an enlarged view of the optical system extending from the spatial light modulator 203 to the holographic optical disk 205.

In FIG. 1 and FIG. 2, a focal distance of a relay lens 301a on the spatial light modulator 203 side is f₁. A focal distance of a relay lens 301b on an objective lens 204 side by f₂. A focal distance of the objective lens 204 is f₃.

The semiconductor laser 201 emits a blue-violet laser beam having a wavelength of 405 nanometers as a laser beam for recording and reproducing. The polarizing beam splitter 202 divides the linearly polarized laser beam emitted from the semiconductor laser 201 into two light beams. Between the two light beams, a light beam that passes through the polarizing beam splitter 202 enters the spatial light modulator 203. The spatial light modulator performs an intensity modulation or a phase modulation on the light beam. The light beam is converted to an information light carrying information.

According to the first embodiment, a transmissive liquid crystal element is used as the spatial light modulator 203. The information light carries binary-patterned information (data page), in which information to be recorded is digitally encoded and an error-correcting code is included. The information light includes large numbers of bright spots and dark spots.

The information light passes through the permeable material 102 and enters the spatial filter 301. The permeable material 102 will be described in detail hereafter.

The spatial filter 301 includes a pair of relay lenses 301a and 301b, and an iris diaphragm 301c. The relay lenses 301a and 301b propagate the information light that has passed through the spatial light modulator 203 to the objective lens 204. The iris diaphragm 301c removes unnecessary high-order diffraction light and noise from the information light from the relay lens 301a.

The objective lens (condenser lens) 204 converges an information light 604, from which the spatial filter 301 has removed the unnecessary high-order diffraction light and noise, onto the holographic optical disk 205. The information light 604 is irradiated onto the holographic optical disk 205.

At the same time, between the two light beams divided by the polarizing beam splitter 202, a light beam reflected by the polarizing beam splitter 202 is polarized in a same direction as the information light by the wavelength plate 206. The beam reducing optical system 207 reduces a diameter of the light beam to a predetermined beam diameter. Then, after the beam diameter is reduced, the light beam is irradiated onto the holographic optical disk 205 as a reference light 605.

In the information recording layer of the holographic optical disk 205, the information light 604 and the reference light 605 irradiated as described above interfere with each other. Information is recorded in three-dimensional form onto the information recording layer as a fine interference fringe.

According to the first embodiment, a driving device (not shown) moves (shifts) the holographic optical disk 205 by a shifting distance for a shifted, multi-layered recording. A multi-layered recording is performed by subsequent pieces of information being successively recorded as described above.

Photopolymer is used as a material for the information recording layer of the holographic optical disk 205. Photopolymer is a photosensitive material using photopolymerization of a polymerizable compound (monomer). The information recording layer generally includes a monomer, a polymerizable initiator, and a porous matrix as main components. The porous matrix serves to retain volume before and after a recording. The information recording layer of the holographic optical disk has a thickness of several hundred micrometers to achieve a diffraction efficiency sufficient for signal reproduction.

When the information recorded in the information recording layer of the holographic optical disk 205 is reproduced, the reference light 605 is irradiated onto the information recording layer of the holographic optical disk 205 in which the information is recorded. A transmitted, diffracted light is the reference light from the interference fringe recorded in the information recording layer that passes through to a surface on a side of the holographic optical disk 205 opposite of a surface on which the reference light is irradiated onto the holographic optical disk 205. The transmitted, diffracted light enters the objective lens 601 and becomes a parallel light beam. A mirror 606 reflects the parallel light beam. The reflected light beam forms an image on the two-dimensional image sensor element 603, through the relay lenses 602a and 602b. The imaged light is acquired as a two-dimensional image. When the information is reproduced, the driving device (not shown) moves (shifts) the holographic optical disk 205 by the shifting distance. The recorded pieces of information are successively reproduced as described above.

According to the embodiment, as shown in FIG. 1 and FIG. 2, the holding component 103 is disposed between the spatial light modulator 203 and the relay lens 301a on the spatial light modulator 203 side. The holding component 103 is a hollow structure. The information light that passes through the spatial light modulator 203 enters a cavity within the holding component 103. The cavity within the holding component 103 is filled with the permeable material 102. A cross-sectional view of the holding component 103 is shown in FIG. 1 and FIG. 2.

The permeable material 102 refracts the information light that passes through the spatial light modulator 203 and allows the information light to transmit. The permeable material 102 has a refractive index that is greater than a refractive index of air (about 1.0) and is smaller than a refractive index of the relay lens 301a. The permeable material 102 is, for example, cedarwood oil or cedar oil. However, the permeable material 102 can be arbitrarily selected based on the refractive index of the relay lens 301a.

A reason for providing the permeable material 102, such as that described above, between the spatial light modulator 203 and the relay lens 301a according to the embodiment will be described.

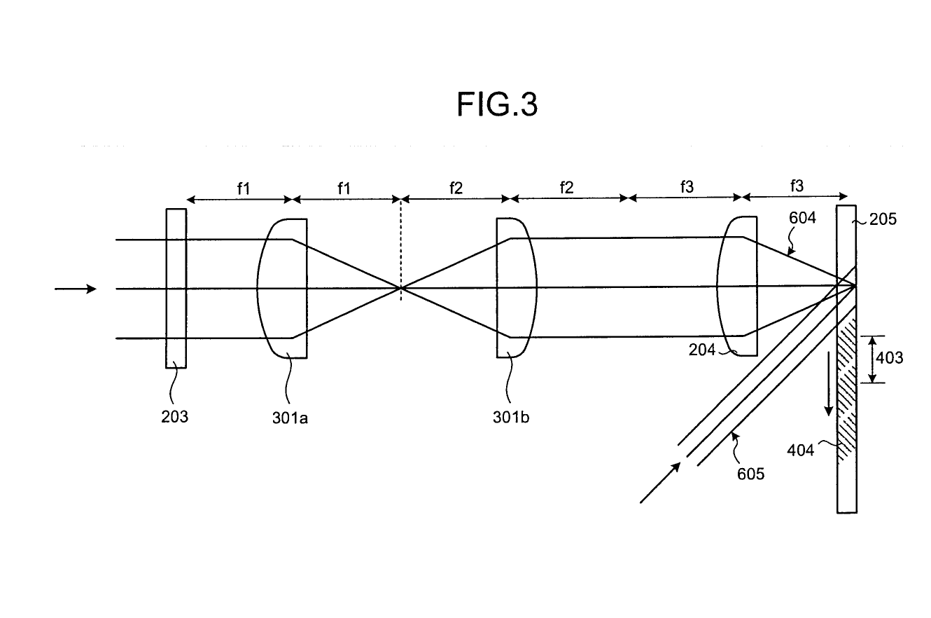

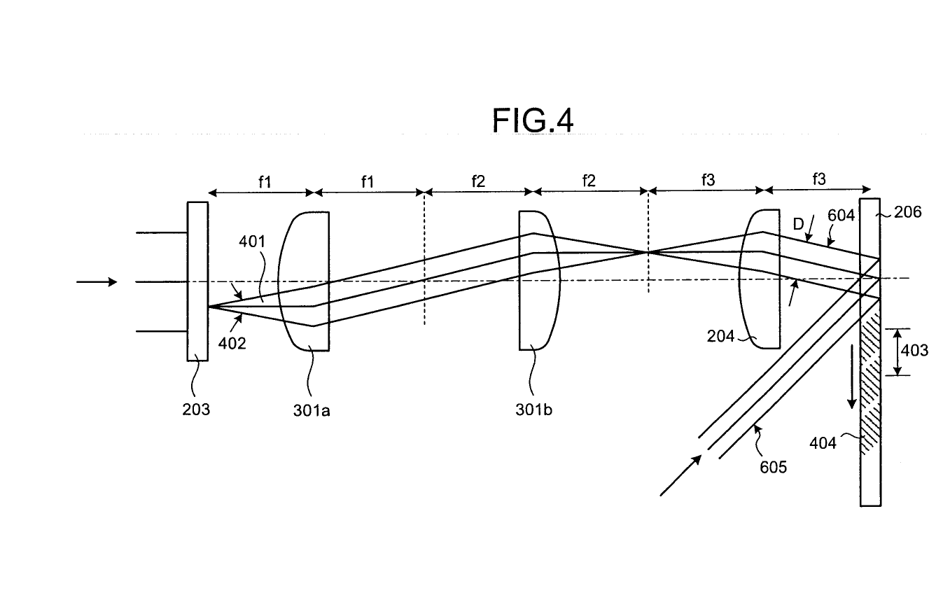

FIG. 3 is a schematic diagram of an information light irradiation state e from the spatial light modulator 203 to the holographic optical disk 205. FIG. 4 is a schematic diagram of an irradiation state of a light from a single pixel in the spatial light modulator 203. The irradiation state refers to a state in which the information light is irradiated up to the holographic optical disk 205, when focus is placed on the light from the single pixel. When lights from all pixels are indicated using the light beam from the single pixel in FIG. 4, an irradiation state is that shown in FIG. 3. The permeable material 102 is omitted in FIG. 3 and FIG. 4.

The focal distance is a distance shown in the diagrams. An image from the spatial light modulator 203 is formed in a focal position on a relay lens 301b side of the objective lend 204 (a position indicated by a dotted line on a border between f₂ and f₃ in FIG. 4).

An information light 401 emitted from the single pixel of the spatial light modulator 203 changes states from being divergent, to parallel, to converged, and then to parallel, as shown in FIG. 4. The information light 401 is then irradiated onto the information recording layer in the holographic optical disk 205. In other words, the light emitted from the single pixel in the spatial light modulator 203 can be considered to be a rough point source. Therefore, the light enters the relay lens 301a as a spherical wave. After the light is refracted by the relay lens 301a and passes through the relay lens 301a, the light becomes the parallel light beam. Next, after the parallel light beam is refracted by the relay lens 301b and passes through the relay lens 301b, the parallel light beam become a convergent light beam. The convergent light beam is then refracted by the objective lens 204 and passes through the objective lens 204. The convergent light beam becomes the parallel light beam. The parallel light beam enters the holographic optical disk 205. A beam diameter D of the information light entering the holographic optical disk 205 is expressed by the above-mentioned expression (1), when the pixel pitch of the spatial light modulator 203 is P and the wavelength of the laser beam emitted from the semiconductor laser 201 in air is λ₀.

In the expression (1), 2λ₀/P indicates a divergence angle 402 of the light from the single pixel of the spatial light modulator 203. Therefore, the beam diameter at the relay lens 301a having the focal distance of f₁ is 2λ₁/P.

The beam diameter of the information light at the relay lens 301b having the focal distance of f₂ and the objective lens 204 having the focal distance of f₃ becomes f₃/f₂-folds. As a result, the beam diameter D is expressed by the expression (1).

The information light 604, having the beam diameter D expressed by the expression (1), and the reference light 605 interfere with each other within the information recording layer in the holographic optical disk 205. An interference fringe 404 is formed. The information is recorded in the information recording layer of the holographic optical disk 205 as a hologram.

As shown in FIG. 3 and FIG. 4, the driving device (not shown) moves (shifts) the holographic optical disk 205 by a shifted distance 403. As a result, the shifted, multi-layered recording is performed. When the shifted, multi-layered recording is performed, the shorter the shifted distance 403 is, the higher the density of the recording. However, to achieve this, the beam diameter D of the information light 604 is required to be reduced.

As is clear from each parameter in the expression (1), following methods can be considered to reduce the beam diameter D.

A first method involves shortening the wavelength λ₀ of the laser beam emitted from the semiconductor laser 201.

A second method involves increasing the pixel pitch P of the spatial light modulator 203.

A third method involves shortening the focal distance f₁ of the relay lens 301a on the spatial light modulator 203 side.

A fourth method involves lengthening the focal distance f₂ of the relay lens 301b on the objective lens 204 side.

A fifth method involves shortening the focal distance f₃ of the objective lend 204.

However, when the first method is used, the shortening of the wavelength of the laser beam to a wavelength shorter than a wavelength of 405 nanometers of the currently used blue-violet laser is not realistic. When the second method is used, when the pixel pitch of the spatial light modulator increases, an amount of data modulated by the spatial light modulator 203 decreases. When the third method is used, a size of the spatial light modulator 203 that has about 500×500 pixels and of which the pixel pitch is 15 micrometers is 7.5 millimeters (500×15 micrometers). Taking into consideration the size of the spatial light modulator 203, a significant shortening of the focal distance of the relay lens 301a on the spatial light modulator 203 side is difficult to achieve because a certain amount of relay lens 301a lens aperture is required. When the fourth method is used, the optical system becomes excessively large when the optical path extends in accompaniment to the lengthening of the focal distance. Size reduction of the device becomes difficult to achieve. When the fifth method is used, an incidence path for the reference light is required to be secured. Therefore, the optical system becomes excessively large, making size reduction of the device difficult to achieve.

Therefore, in the optical information recording/reproducing apparatus according to the embodiment, the holding component 103 filled with the permeable material 102 is provided between the spatial light modulator 203 and the relay lens 301a on the spatial light modulator 203 side. Through substantial reduction of the value of (2λ₀/P) in the expression (1), the beam diameter D of the information light can be reduced without using the first to fifth methods.

In other words, the permeable material 102 filling the holding component 103 is a material having a refractive index that is greater than the refractive index of air (about 1.0). Therefore, when the refractive index of the permeable material 102 is n, the wavelength of the information light refracted in the permeable material 102 and passing through the permeable material 102 becomes shorter by (1/n). Therefore, a divergence angle 101 of the information light emitted from the single pixel of the spatial light modulator 203 (see FIG. 2) is 2λ₀/(nP). Compared to a conventional device in which the permeable material 102 is not provided between the spatial light modulator 203 and the relay lens 301a, the divergence angle 101 is reduced by (1/n). In other words, the value of (2λ₀/P) in the expression (1) essentially becomes 2λ₀/(nP) as a result of the information light being refracted in the permeable material 102 and passing through the permeable material 102. The beam diameter D of the information light can be reduced without the wavelength λ₀ of the laser beam, the focal distance f₁ of the relay lens 301a, the focal distance f₂ of the relay lens 301b, and the focal distance f₃ of the objective lens 204 being changed.

According to the embodiment, taking into consideration the refractive index n of the permeable material 102, a lens shape of the relay lens 301a is designed such that the relay lens 301a has a refractive index greater than the refractive index n. As a result, even when the permeable material 102 having a greater refractive index n than the refractive index of air is present between the spatial light modulator 203 and the relay lens 301a, the refractive index at the relay lens 301a does not decrease.

Next, a design example of an optimized lens shape of the relay lens 301a, such as that described above, will be described. FIG. 5 is a schematic diagram explaining the design example of the optimized lens shape of the relay lens 301a. In the design example in FIG. 5, the transmissive liquid crystal element is used as the spatial light modulator 203. The permeable material 102 is assumed to have a refractive index of 1.5. An aspheric lens is used as the relay lens 301a. In FIG. 5, a reference number 503 indicates a position (optical spot) at which the information light converges.

A glass material used in the aspheric lens is LaSFN9 (trade name, manufactured by SCHOTT GLAS Ltd.). The refractive index is 1.85026 at a laser wavelength of 405 nanometers. A surface 301d (referred to, hereinafter as a first surface) on the spatial light modulator 203 side of the relay lens 301a that is an aspheric lens is an aspheric surface. A surface (referred to, hereinafter, as a second surface) on the objective lens 204 side that is a side through which the information light exits is a spherical surface.

In the lens design example of the relay lens 301a according to the embodiment, a lens thickness is 3.6 millimeters. The focal distance f₁ is 10 millimeters. A lens numerical aperture is 0.25. Taking into consideration the size of the spatial light modulator 203 (500×15 micrometers=7.5 millimeters), a focal distance f₁ of about 10 millimeters is required.

Lens shape data in the lens design example of the relay lens 301a according to the embodiment is shown in Table 1.

TABLE 1

| | first surface | second surface |
|---|---|---|
| curvature radius r | 5.02647 | −36.75626 |
| CC | −0.99996 | — |
| C₄ | 5.4273 × 10⁻⁵ | — |
| C₆ | −2.8291 × 10⁻⁶ | — |
| C₈ | −2.7150 × 10⁻⁸ | — |
| C₁₀ | 2.0867 × 10⁻¹⁰ | — |

A definition of the aspheric surface in the example and a definition of each parameter are as stated in expression (2).

$$z = \frac{( 1 / r ) {h}^{2}}{1 + \sqrt{1 - {( 1 / r )}^{2} ( 1 + CC ) {h}^{2}}} + {C}_{4} {h}^{4} + {C}_{6} {h}^{6} + {C}_{8} {h}^{8} + {C}_{10} {h}^{10} \qquad ( 2 )$$

where, h is a height from optical axis, z is a distance from a tangent plane of an peak of an aspheric surface to a point of height h on the aspheric surface, CC is a cone constant, and C₄ to C₁₀ are aspheric surface coefficient.

In the lens design example of the relay lens 301a according to the embodiment, a standard deviation of a wave front aberration that is an indicator of lens performance is 1.05×10⁻⁷ λrms. The wave front aberration is sufficiently less than 0.07 μrms that is considered to be a diffraction performance limit.

The lens design example of the relay lens 301a described above is an example and is not limited thereto. For example, the relay lens 301a can be a bi-aspherical surface lens, enhancing lens performance including tolerance characteristics.

Next, an example of a specific value of the beam diameter D of the information light will be described. In an optical system of a conventional, common optical information recording/reproducing apparatus, the wavelength λ₀ of the laser beam is 405 nanometers. The pixel pitch P of the spatial light modulator 203 is about 15 micrometers. The focal distance f₁ of the relay lens 301a is 10 millimeters. The focal distance f₂ of the relay lens 301b is 100 millimeters. The focal distance f₃ of the objective lens 204 is 20 millimeters. In this case, the beam diameter D of the information light entering the holographic optical disk 205 is about 100 micrometers. Therefore, the shifted distance 403 when the shifted, multi-layered recording is performed is limited by the beam diameter D of 100 micrometers. The shifted distance 403 cannot be made shorter than the beam diameter D.

On the other hand, in the optical information recording/reproducing apparatus according to the embodiment, in the above-described example, the refractive index n (=1.85026) of the permeable material 102 is provided between the spatial light modulator 203 and the relay lens 301a. Therefore, the wavelength of the information light within the permeable material 102 becomes (1/n)-fold. As a result of the expression (1), the beam diameter D is reduced to about 70 micrometers. Therefore, the shifted distance 403 for when the shifted, multi-layered recording is performed can be made shorter compared to the conventional device.

Shifting directions of the shifted, multi-layered recording are two-dimensional directions. In other words, the shifting directions are two radial directions: a track direction of the holographic optical disk 205 and a direction perpendicular to the track. Therefore, recording density can be increased by two squares of the refractive index. In the example described above, the recording density is 2.25 (1.5×1.5) times that of the conventional device. Through optimization of the shape of the relay lens 301a, the recording density of the holographic optical disk 205 can be enhanced without the size of the optical information recording/reproducing apparatus being increased.

A technology for increasing a resolution of an objective lens using microscope technology, in which an area between the objective lens and an observation subject material is immersed in a material having a high refractive index, such as water or oil, (in other words, oil-immersed) exists. However, in the technology used in the optical information recording/reproducing apparatus according to the first embodiment, a high-refractive-index permeable material is not used to enhance the resolution of the lenses. Rather, the technology is used to perform high-density recording onto the holographic optical disk using the spatial light modulator 203. The technology used in the optical information recording/reproducing apparatus according to the first embodiment is fundamentally different from the above-described technology using the microscope technology.

In other words, in the optical information recording/reproducing apparatus according to the first embodiment, the permeable material 102 having a refractive index greater than the refractive index of air is provided between the spatial light modulator 203 and the relay lens 301a. The lens shape of the relay lens 301a is optimized such that the refractive index of the permeable material 102 is smaller than the refractive index of the relay lens 301a. As a result, the diffraction divergence angle of the light from the single pixel of the spatial light modulator 203 is reduced, and the beam diameter D of the information light entering the holographic optical disk 205 is reduced. Thus, enhanced recording density of the holographic optical disk 205 can be achieved without the size of the optical information recording/reproducing apparatus being increased.

In the optical information recording/reproducing apparatus according to the first embodiment, the transmissive liquid crystal element is used as the spatial light modulator 203. However, a reflective spatial light modulator is used in an optical information recording/reproducing apparatus according to a second embodiment.

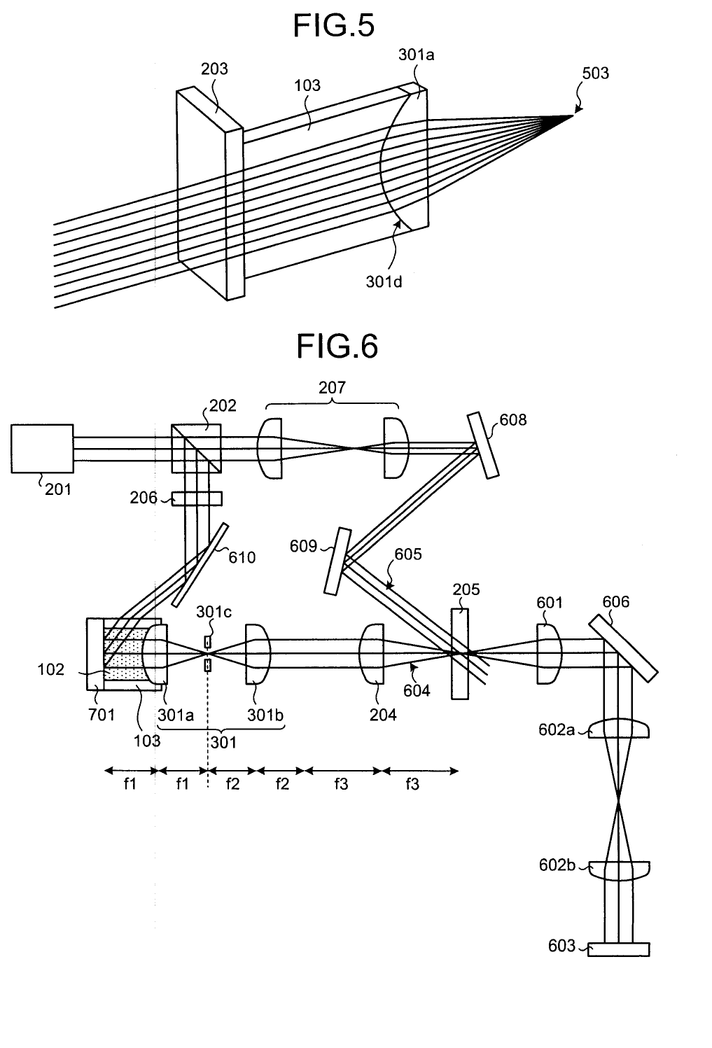

FIG. 6 is a configuration diagram of the optical information recording/reproducing apparatus according to the second embodiment. As according to the first embodiment the two-beam system is also used in the optical information recording/reproducing apparatus according to the second embodiment.

An optical system of the optical information recording/reproducing apparatus according to the second embodiment mainly includes the semiconductor laser 201, the semiconductor laser 201, the polarizing beam splitter 202, a spatial light modulator 701, the holding component 103, the spatial filter 301, the objective lenses 204 and 601, the wavelength plate 206, mirrors 608, 609, 606, and 610, the beam reducing optical system 207, the relay lenses 602a and 603b, and the two-dimensional image sensor element 603. The semiconductor laser 201 emits the laser beam. The holding component 103 is filled with the permeable material 102. The two-dimensional image sensor element 603 is, for example, CMOS or CCD.

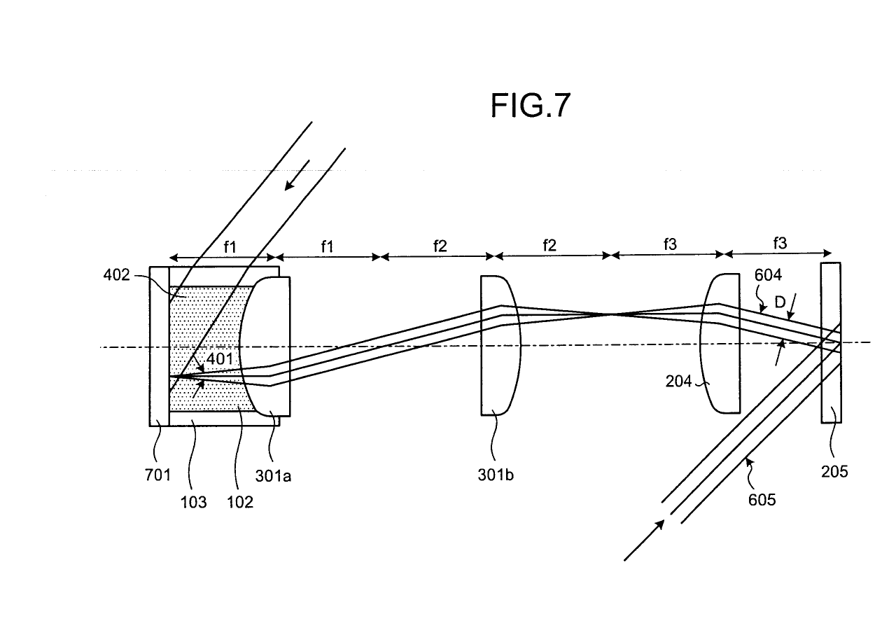

FIG. 7 is an enlarged view of an optical system extending from the spatial light modulator 701 to the holographic optical disk 205. In FIG. 6 and FIG. 7, the focal distance of the relay lens 301a on the spatial light modulator 701 side is f₁. The focal distance of the relay lens 301b on the objective lens 204 side is f₂. The focal distance of the objective lens 204 is f₃.

According to the second embodiment, the spatial light modulator 701 uses a reflective digital micro-mirror device (DMD). As according to the first embodiment, the hollow holding component 103 is disposed between the DMD 701 and the relay lens 301a. The information light reflected by the DMD 701 enters the cavity of the holding component 103. The cavity of the holding component 103 is filled with the permeable material 102. The information light reflected by the DMD 701 passes through the permeable material 102. As according to the first embodiment, the permeable material 102 has a reflective index n that is greater than the reflective index of air (about 1.0) and is smaller than the reflective index of the relay lens 301a.

The polarizing beam splitter 202 divides the linearly polarized laser beam emitted from the semiconductor laser 201 into two light beams. Between the two light beams, the light reflected by the polarizing beam splitter 202 is polarized by the wavelength plate 206. The light beam is reflected by a mirror 610 and enters the DMD 701 that is the spatial light modulator. The DMD 701 performs a light intensity modulation or a phase modulation on the light beam. The light beam is converted to the information light carrying information. The information light passes through the permeable material 102 and enters the spatial filter 301.

As according to the first embodiment, the spatial filter 301 includes the pair of relay lenses 301a and 301b, and the iris diaphragm 301c. The objective lens (condenser lens) 204 converges the information light 604, from which the spatial filter 301 has removed the unnecessary high-order diffraction light and noise, onto the holographic optical disk 205. The information light 604 is irradiated onto the holographic optical disk 205.

At the same time, between the two light beams divided by the polarizing beam splitter 202, the light beam that passes through the polarizing beam splitter 202 is polarized in the same direction as the information light by the wavelength plate 206. The beam reducing optical system 207 reduces the diameter of the light beam to the predetermined beam diameter. After the beam diameter is reduced, the light beam is reflected by a mirror 608 and a mirror 609. The light beam is irradiated onto the holographic optical disk 205 as a reference light 605.

In the information recording layer of the holographic optical disk 205, the information light 604 and the reference light 605 irradiated as described above interfere with each other. Information is recorded in three-dimensional form onto the information recording layer as the fine interference fringe.

As according to the first embodiment, the driving device (not shown) moves (shifts) the holographic optical disk 205 by the shifting distance for the shifted, multi-layered recording. The multi-layered recording is performed by subsequent pieces of information being successively recorded as described above.

The optical system for reproducing the information recorded in the information recording layer of the holographic optical disk 205 is the same as that according to the first embodiment. Explanations thereof are omitted.

Same as in the first embodiment, the permeable material 102 according to the second embodiment has a refractive index n that is greater than the refractive index of air (about 1.0) and smaller than the refractive index of the relay lens 301a. The lens shape design of the relay lens 301a on the DMD 701 side is the same as that according to the first embodiment. Therefore, in the optical information recording apparatus according to the second embodiment, the beam diameter D of the information light entering the holographic optical disk 205 can be reduced without the size of optical information recording/reproducing apparatus being increased, as according to the first embodiment. The recording density of the holographic optical disk 205 can be enhanced.

In the optical information recording/reproducing apparatus according to the first embodiment and the second embodiment, the permeable material 102 is provided between spatial light modulators 301 and 701 and the relay lens 301a. However, according to a third embodiment, the permeable material 102 is provided between the spatial light modulator 203 and the objective lens.

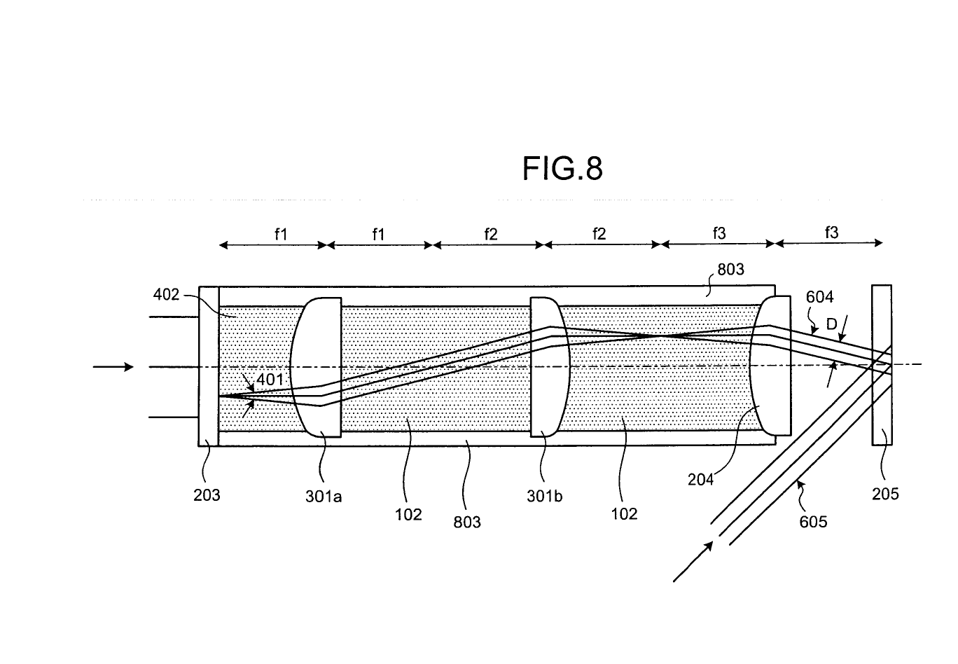

FIG. 8 is an enlarged view of an optical system extending from the spatial light modulator 203 to the holographic optical disk 205. As shown in FIG. 8, in the optical information recording/reproducing apparatus according to the third embodiment, a hollow holding component 803 is provided between the spatial light modulator 203, which is the transmissive liquid crystal element, and the objective lens 204. In other words, the holding component 802 provided between the spatial light modulators 203 and 701 and the relay lens 301a according to the first embodiment and the second embodiment is provided such as to further extend to the objective lens 204. The relay lenses 301a and 301b are provided within a cavity of the holding component 803. The cavity is filled with the permeable material 102. In other words, according to the embodiment, the permeable material 102 fills an area between the spatial light modulator 203 and the relay lens 301a, an area between the relay lens 301a and the relay lens 301b, and an area between the relay lens 301b and the objective lens 204. The optical system including the spatial light modulator 203, the relay lens 301a, the relay lens 301b, and the objective lens 204 is a single package.

The permeable material 102 has a refractive index that is greater than the refractive index of air and is smaller than the refractive index of the relay lens 301a. As according to the first embodiment, the permeable material 102 can be cedar oil or the like. The lens shape of the relay lens 301a is designed as according to the first embodiment. The relay lens 301a is designed to have a desired refractive index that is greater than the refractive index of the permeable material 102.

In the optical information recording/reproducing apparatus according to the third embodiment, the beam diameter D of the information light entering the holographic optical disk 205 can be reduced without the size of the optical information recording/reproducing apparatus being increased, as according to the first embodiment. The recording density of the holographic optical disk 205 can be enhanced.

According to the first to third embodiments described above, examples in which the present invention is applied to the optical information recording/reproducing apparatus including the optical system for reproducing information from the holographic optical disk 205 are explained. However, the present invention can also be applied to an optical information recording apparatus that does not include the optical system for reproducing the information from the holographic optical disk 205, but includes the optical system for recording information onto the holographic optical disk 205.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical information recording apparatus comprising:
a light source that emits an irradiation light;
a spatial light modulator that converts the irradiation light to an information light carrying information;
a condenser lens that converges the information light and a reference light onto an optical information recording medium on which the information can be recorded as a hologram by an interference fringe formed by an interference between the information light and the reference light;
a relay lens that propagates the information light emitted from the spatial light modulator to the condenser lens; and
a permeable member that is provided between the spatial light modulator and the relay lens, has a refractive index greater than a refractive index of air and smaller than a refractive index of the relay lens, and refracts and transmits the information light.

2. The apparatus according to claim 1, wherein the permeable member is provided to extend from the relay lens to the condenser lens.

3. The apparatus according to claim 1, wherein the permeable member includes a permeable material having a refractive index greater than a refractive index of air and smaller than a refractive index of the relay lens, and a holding component that holds the permeable material.

4. The apparatus according to claim 3, wherein the permeable material is cedarwood oil or cedar oil.

5. The apparatus according to claim 1, wherein the relay lens includes a pair of lenses; and
an information light incidence surface of a lens disposed on a side from which the information light enters is an aspheric surface, among the pair of lenses.

6. The apparatus according to claim 1, wherein the spatial light modulator transmits the irradiation light emitted from the light source to convert the irradiated light to the information light.

7. The apparatus according to claim 1, wherein the spatial light modulator reflects the irradiation light emitted from the light source to convert the irradiation light to the information.
